(19) United States
(12) Patent Application Publication
(10) Pub. No.: US 2012/0160357 A1
(43) Pub. Date: Jun. 28, 2012

(54) VORTEX RING GENERATOR

(75) Inventors: Bryan Weis, Aumsville, OR (US); Dustin Baker, Silverton, OR (US); Jerry Weis, Stayton, OR (US)

(73) Assignee: VIS, LLC, Stayton, OR (US)

(21) Appl. No.: 13/335,807

(22) Filed: Dec. 22, 2011

Related U.S. Application Data
(60) Provisional application No. 61/426,417, filed on Dec. 22, 2010.

(51) Int. Cl. F15C 1/16

(52) U.S. Cl. 137/808

(57) ABSTRACT

Embodiments of the present concept are directed to a Vortex Ring Generator (VRG) that generates vortexes or rings of air that can be sent toward various targets to apply force to that target. In one example, a vortex ring generating system includes a first fuel source, a second fuel source, and a combustion chamber connected to each of the first and second fuel sources through respective fuel control valves. The system also includes a vortex cone connected to the combustion chamber, the cone structured to form vortex rings of air in response to fuel in the combustion chamber being ignited. A control unit controls at least some of the valves and an ignitor connected to the combustion chamber to control the generation of the vortex rings.

### RELATED APPLICATIONS

This application claims priority to U.S. Provisional Application No. 61/426,417 filed Dec. 22, 2010, entitled VORTEX RING GENERATOR, the contents of which are hereby incorporated by reference.

### FIELD OF THE INVENTION

This disclosure relates generally to vortex ring generators, and more particularly to vortex ring generators configured to generate vortex rings of air pressure capable of applying physical pressure on a variety of substrates at varying rates.

### BACKGROUND

There are currently an estimated 110 million land mines throughout the world. Countries like Angola, Columbia and Afghanistan have the need to remove thousands of mines in order to make the land safe to use for farming, to travel over, and to allow recreation. Children are among the most affected by land mines as they often play in open spaces while being unaware of dangers. Land mines are triggered in a variety of ways. The most common is by a pressure sensor that when depressed causes the mine to detonate.

The current method of de-mining ranges from hand held metal detectors to chain flails to unmanned aerial vehicles (UAVs) with extremely sophisticated electronics that can detect mines. Flails generally consist of a tractor with a large spinning drum, at the front, with chains attached to it. These chains slap the ground and detonate mines. Flails can be an effective method of de-mining an area, but it is often complicated by rough terrain or other obstacles. Additionally, the operator of the vehicle needs to be relatively close to where the mines are being detonated, putting them at hazard from a variety of dangers associated with detonating mines at close range.

Clearing mines is extremely dangerous. According to the UN, for every 2000 mines cleared there is an accident that kills or maims someone who was clearing the ground. The monetary cost to clear mines is anywhere between $300 and $1000 per cleared mine. Every month land mines kill or maim as many as 2000 people. Some of these mines have been lying dormant for the last 50 years.

### SUMMARY

Embodiments of the present concept are directed to a Vortex Ring Generator (VRG) that generates vortexes or rings of air that can be sent toward various targets to apply force to that target. One application of this technology is in the detonation of hidden mines. Here the force generated by the vortex of air sets off the pressure switch of the mine. The VRG has electronic control that can dictate and vary the rate of fire of the vortexes. For example, the electronic control can set the fire rate of 3 Hz, which corresponds to three vortexes being fired per second. This allows a helicopter or other vehicle to use the device to sweep over areas of land and clear any mines that may be hidden on that land. In one embodiment, the components of the VRG include a combustion chamber connected to one or more fuel sources with one or more valves, a cone connected to the combustion chamber and structured to generate a vortex of air in response to force generated in the combustion chamber, and a control unit configured to regulate the one or more valves and an ignition system in the combustion chamber. By regulating the one or more valves and ignition system, the control unit can control the rate of vortex generation. The control unit may also be configured to receive feedback from the valves, combustion chamber, cone, or user to change or optimize the rate of vortex generation.

### BRIEF DESCRIPTION OF THE DRAWINGS

FIG. 1 is a functional block diagram of a vortex ring generator according to embodiments of the invention.

FIG. 2 is a functional block diagram of another vortex ring generator according to embodiments of the invention.

FIG. 3 is a detail diagram of an example vortex ring generator according to embodiments of the invention.

FIG. 4 is a detail diagram of the vortex ring generator shown in FIG. 3 mounted to a helicopter according to embodiments of the invention.

FIG. 5 is a detail diagram of three of the vortex ring generators shown in FIG. 3 mounted in parallel to a helicopter according to embodiments of the invention.

FIG. 6 a detail diagram of the vortex ring generator shown in FIG. 3 mounted to a loader according to embodiments of the invention.

FIG. 7 is a functional block diagram of vortex ring generator according to embodiments of the invention.

FIG. 8 is a flow diagram of a method of generating a vortex air ring with a vortex ring generator according to embodiments of the invention.

### DETAILED DESCRIPTION

As discussed above, clearing mines in war ravaged countries is difficult, dangerous, time consuming, and expensive. To address these issues, embodiments of the present concept provide a vortex ring generator (VRG) that generates vortexes or rings of air that can be fired toward areas of land with hidden landmines to detonate the mines by setting off the pressure switches of the mines with the vortexes of air.

Vortex rings are doughnut-shaped rings of air that generally maintain their shape as they travel through the air. Unlike pressure waves of sounds or other concussive forces, the particles of air in vortex rings actually move through the air rather than simply colliding with adjacent particles in a wave-like chain reaction. Because of this phenomenon, vortex rings can be directed in particular directions without much downstream dispersion. However, vortex rings can be difficult to generate and maintain because of instability issues. They have been studied extensively in both academic and military settings for purposes ranging from fluid mechanic observations to crowd control.

In the present concept, vortex rings are generated with a system that utilizes a firing system designed to generate useful and stable vortex rings, as well as a variable control and trigger system to fire and re-fire vortex rings at different intervals. The rate of fire for this VRG system is variable so that it can be optimized for particular uses. For example, in a de-mining application that uses the disclosed VRG system, the rate of fire may be set at 3 Hz or three shots per second. In another example, for an avalanche triggering application, the system may be configured to have a firing rate of 0.5 Hz or one shot every two seconds. These and other applications of the system are discussed below, along with detailed embodiments of the vortex ring generating system.

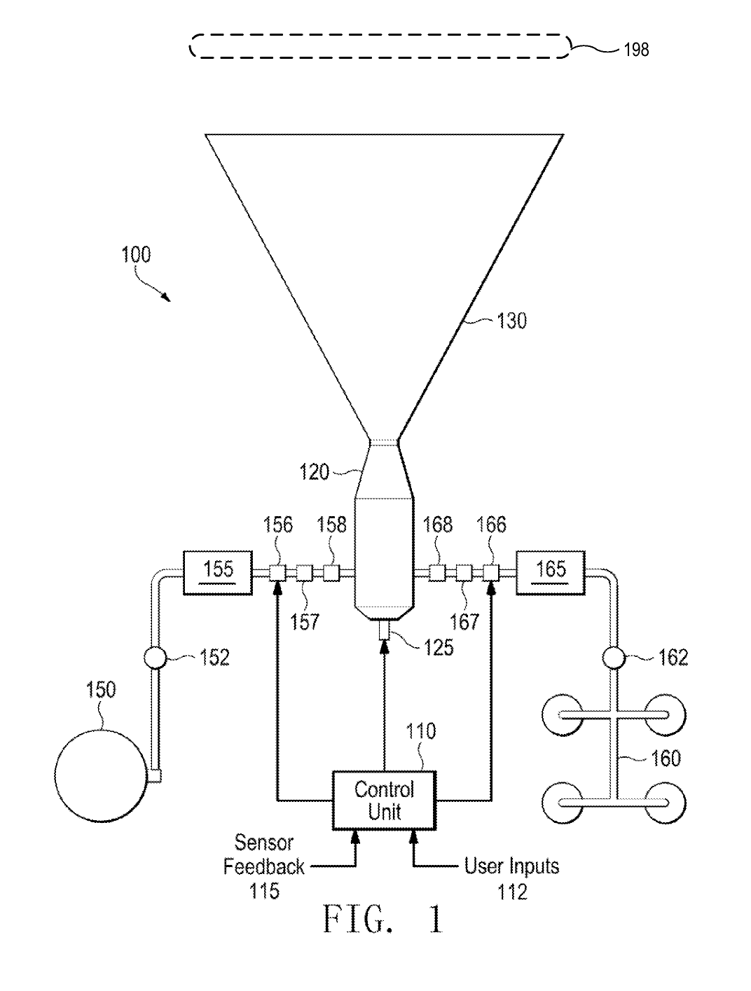

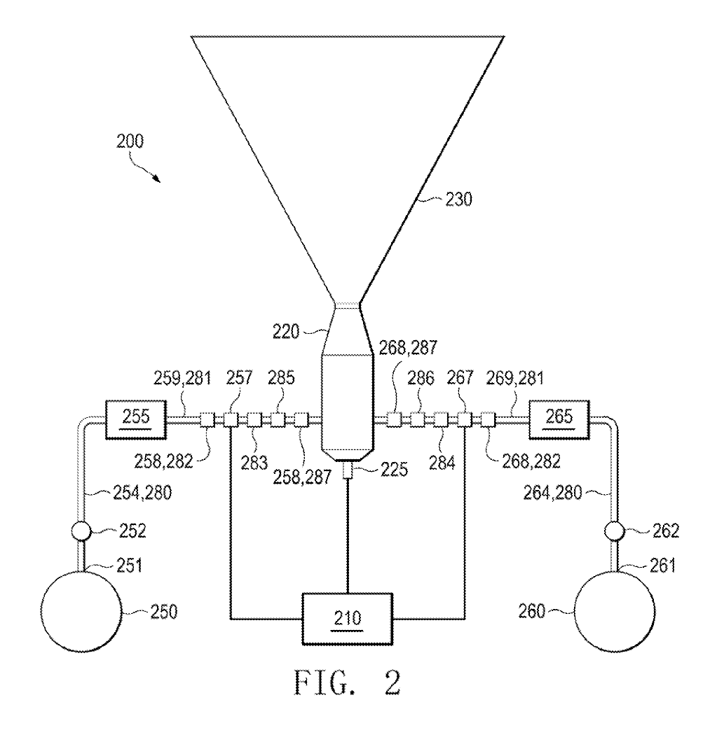

FIGS. 1 and 2 are functional block diagrams of a vortex ring generators according to embodiments of the invention. FIG. 1 provides an overview of an example VRG system and FIG. 2 illustrates another similar system with reference numerals that match up with an example bill of materials listed in Table 1 below.

Referring to FIG. 1, an example vortex ring generator 100 is powered by mixing two fuels, such as oxygen and propane and igniting this highly combustible mixture of gas. The gases are provided from a first fuel supply container 150 and a second fuel supply container 160. The fuel gases are mixed and then ignited in a combustion chamber 120. Once the gases are ignited by an ignitor 125, the gases explode and the explosion rushes out of the combustion chamber 120 and into a vortex cone 130. The cone 130 is specifically shaped to generate a desired vortex ring 198 from the explosive forces leaving the combustion chamber 120. In addition, the cone 130 provides a mechanism to direct the vortex rings 198 in a desired direction. The high pressure from these vortex rings 198 can be substantial enough to provide the pressure needed to set off a mine. By firing these vortex rings 198 from an elevated position toward the ground an operator is able to traverse forward and lay vortex ring after vortex on to the ground providing a “foot print” of pressure on the ground and detonating any mines that may be under the this foot print of air.

In this example VRG system 100, the combustion chamber 120 is structured to allow the fuel gases to mix and be ignited to create an explosion. In some embodiments, the combustion chamber 120 is a substantially cylindrical steel tank of about 13 gallons that tapers down to a 4 inch diameter nozzle. The cone 130 is about 7 feet in length and increases in diameter from about 4 inches at the interface with the combustion chamber to about 4 feet in diameter at the opposite end.

In the first fueling system, for example oxygen, an oxygen tank 150 is used as a storage tank for pressurized oxygen. A regulator 152 regulates the pressure of oxygen through the initial part of the oxygen fueling system. An oxygen expansion tank 155 allows a large volume of oxygen to be held at a set pressure through the rest of the oxygen fueling system. A solenoid valve 156 acts as a gate for the oxygen to be let into the combustion chamber 120, and may be controlled by a control unit 110. A flow control valve 157 regulates the flow of oxygen as it leaves the solenoid valve 156, and a check valve 158 keeps explosive gases from re-entering the oxygen supply side. The oxygen may be supplied to the combustion chamber 120 at a pressure substantially higher than atmospheric pressure, such as at about 50 pounds per square inch (psi).

The second fueling system, for example propane, includes similar elements to the first (e.g., oxygen) fueling system. Here, a propane Manifold 160 provides a storage tank for pressurized propane. A regulator 162 regulates the pressure of propane through the propane fueling system. A propane expansion tank 165 allows a large volume of propane to be held at a set pressure through the rest of the propane fueling system. A solenoid valve 166 acts as a gate for the propane to be let into the combustion chamber 120, and also may be controlled by the control unit 110. A flow control value 167 regulates the flow of propane as it leaves the solenoid valve 166, and a check valve 168 keeps explosive gases from re-entering the propane supply side. The propane may also be supplied to the combustion chamber 120 at a pressure substantially higher than atmospheric pressure, such as at 25 psi.

Control over the timing and signaling of these devices is handled by a control unit 110, such as a PC based Programmable Logic Controller. This control unit 110 may also enable the device operator to change various parameters relating to the filling and firing rates to alter the amount of force the device is projecting along with the frequency of said forces. In other embodiments, the control unit 110 may automatically adjust firing parameters of the device in response to feedback signals received from sensors (not shown) in the combustion chamber 120 and/or cone 130.

Listed below in Table 1 is an example bill of materials for one embodiment of the vortex ring generator. The item #s in the table match the reference numerals in FIG. 2. Although specifically dimensioned parts are specified in Table 1, various other sized parts may be used in other embodiments. Additionally, more or fewer parts may be used in other embodiments.

TABLE 1

| Seq # | Qty. | Item # | Description |
|---|---|---|---|
| 1 | 1 | 200 | Vortex generator |
| 2 | 1 | 210 | Control Unit |
| 3 | 1 | 230 | Focusing Cone |
| 4 | 1 | 220 | Combustion Chamber |
| 5 | 1 | 255 | Oxygen Expansion Tank |
| 6 | 1 | 265 | Propane Expansion Tank |
| 7 | 1 | 250 | Oxygen Storage Reservoir |
| 8 | 1 | 260 | Propane Storage Reservoir |
| 9 | 4 | 258, 268 | ¾″ Check Valve |
| 10 | 2 | 285, 286 | 1″ Metering Valve |
| 11 | 1 | 283 | 1″ High Flow Oxygen Spark Arrestor |
| 12 | 1 | 284 | 1″ High Flow Propane Spark Arrestor |
| 13 | 2 | 257, 267 | ¾″ Solenoid Valve |
| 14 | 1 | 259 | ¾″ High flow Oxygen Hose |
| 15 | 1 | 269 | ¾″High flow Propane Hose |
| 16 | 2 | 281 | ¾″ Ball Valve |
| 17 | 2 | 280 | ¼″ Ball Valve |
| 18 | 1 | 252 | High Flow Oxygen Regulator |
| 19 | 1 | 262 | High Flow Propane Regulator |
| 20 | 8 | 282 | ¾″ npt Nipple |
| 21 | 2 | Not | 1″ npt Nipple |
| | | Shown | |
| 22 | 3 | Not | 1/4″ npt Nipple |
| | | Shown | |
| 23 | 4 | 287 | Bushing 1″ npt to ¾″ npt |
| 24 | 1 | 264 | ¼″ Propane Hose |
| 25 | 1 | 261 | ¼″ Propane Tank Adaptor |
| 26 | 2 | 251 | ¼″ npt × RH Oxygen Male Fitting |
| 27 | 1 | 254 | ¼″ Oxygen Hose |
| 28 | 1 | Not | ¼″ npt to Oxygen Tank Fitting |
| | | Shown | |
| 29 | 1 | 225 | Ignitor |

Referring again to FIG. 1, while the above examples provide some embodiments of a VRG system 100, many modifications, and variations are possible in other embodiments. For example, the above example provides a fixed shape cone 130. However, the cone 130 may be structured so that its length and cone wall angle can be changed by an operator or dynamically changed during use. In effect, these changes to the cones are similar to changing the flow shape of a fire hose nozzle. That is, by increasing the end diameter of the cone 130 the size of the vortex rings 198 being shot out the end of the VRG 100 could be changed. For example, as the end diameter of the cone 130 increases, the diameter of the generated vortex rings 198 increase; although the effective target distance where the rings are useful shrinks. This is a trade off, since the vortex rings 198 of air hit the target with a larger area of pressure, but can only be fired from limited distances. On the other hand, a tighter vortex ring 198 is able to travel farther, but would not cover as much of the surface area upon impact because of its smaller diameter. In other embodiments, the cone 130 may be removable and multiple different fixed cones may be used with the VRG system 100 depending on various factors that dictate the type of vortex ring 198 needed.

In the above example VRG system 100, the combustion chamber 120 and cone 130 are fabricated of steel. However, various other materials may be used for the combustion chamber 120, cone 130, and the fueling systems. Although steel is a structurally strong material, it is quite heavy for the amount of strength it provides. Weight of the VRG system 100 may not be an issue in some applications, but in applications where it is flown under a helicopter the weight of the device will be critical. Thus, materials with better strength to weight ratios may be used in some embodiments of the VRG system 100. These materials may include aluminum, aluminum alloys, ceramics, carbon fiber, titanium, fiberglass, plastics, Kevlar, composite materials, or other similar materials.

For the combustion chamber 120, another consideration is heat dispersion. Repeated explosions in the combustion chamber 120 can generate significant heat. Using materials that can quickly displace heat in the combustion chamber 120 may therefore be advantageous in systems designed for firing many vortex rings 198 in a relatively short amount of time. Additionally, a cooling system (now shown) may be implemented around the combustion chamber 120 and/or cone 130 to help displace heat. An example cooling system may include a forced liquid heat exchanger adjacent to the combustion chamber that can draw heat away from the chamber. Other types of heat sinks or heat exchanges may also be used.

In other embodiments, the fueling systems may include various other types of fuels that will create an explosion capable of producing the force necessary to generate a desired vortex ring 198. These fuels may include acetylene, hydrogen, gasoline, or other energy rich sources. These fuels may be supplied to the combustion chamber 120 at pressures much higher than atmospheric pressure to ensure that enough fuel is present in the combustion chamber for each explosion. Additionally, these pressures may be regulated to provide an optimized air-to-fuel ratio. Although an air-to-fuel ratio of approximately 15:1 works for many combustion systems, the precise air-to-fuel ratio will be determined by the fuels used, altitude of use, barometric pressure, and other factors. These fueling systems may also include flash back arresters for additional protection and metering valves to measure fuel usage. The ignition system may include various ignitors 125 from piezoelectric spark generators to automotive based multiple discharge ignition systems that use a coil and spark plug ignition source.

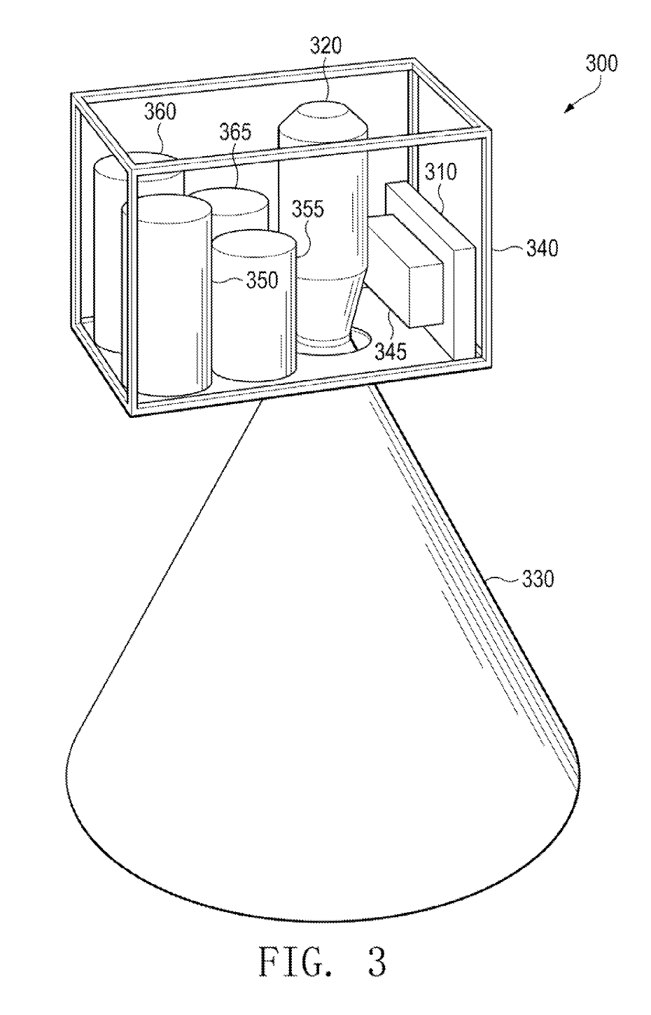

FIG. 3 is a detail diagram of an example vortex ring generator 300 according to embodiments of the invention.

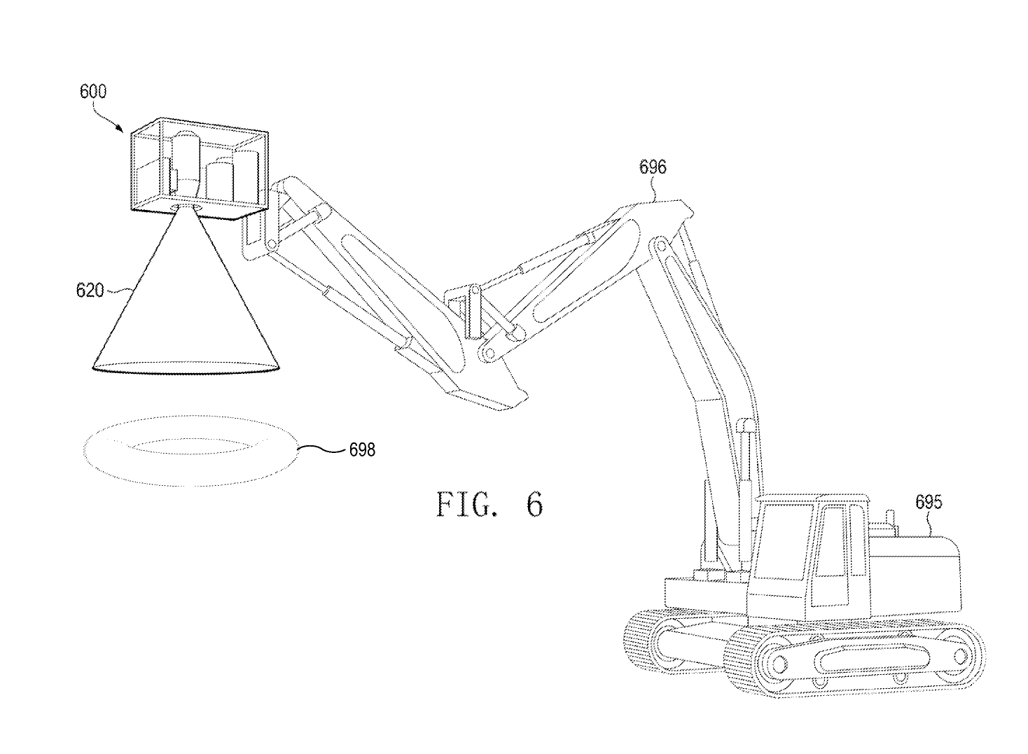

As shown in FIG. 3, the entire VRG system 300 may be enclosed in a housing 340 as an independent unit. Although the housing 340 is shown with open walls, other embodiments may include a housing that encloses all of the components except the end of the cone 330. The open wall housing 340 may allow for better cooling of the combustion chamber 320, while the walled-housing may provide better protection for the components of the VRG system 300. In other embodiments, various elements of the system may be positioned further apart. For example, in embodiments of the VRG 300 where the VRG is positioned in front of a land-based vehicle (see e.g., FIG. 6), the combustion chamber 320 and cone 330 may be positioned in front of the vehicle while the fueling tanks 350, 360 may be positioned in the vehicle to provide better driving stability. Expansion tanks 355, 365 for the fuel may be enclosed in the housing 345 or positioned in the vehicle as well.

A valve box 345 may house some or all of the valves shown in FIGS. 1 and 2. This housing box 345 may protect these valves from contact from external elements and prevent contaminants from interfering with their operation. In some embodiments, the valve box 345 may be maintained within a specified temperature range to ensure optimal operation of the valves.

In some embodiments, the housing 340 may include a dampening system with dampeners attached to the combustion chamber 320. These dampeners may be structured to mute any recoil from the explosions generated in the combustion chamber 320. By lessening or removing recoil, the aim of the cone 330 may not be disrupted between generated vortex rings. Additionally, any vehicle used with the VRG 300 will not have its travel trajectory interfered with by the generated vortex rings.

As discussed above, the high pressure from these vortex rings can be substantial enough to provide the pressure needed to set off a mine. By firing these vortex rings from an elevated position toward the ground an operator would be able to traverse forward and lay vortex ring after vortex on to the ground providing a “footprint” of pressure on the ground and detonating any mines that may be under the this footprint of air.

To elevate this vortex ring generator, the VRG system may be secured under a helicopter or extended from a truck with a boom arm. Securing the vortex ring generator and flying it under a helicopter may be the preferred method because of the ease of flying over rough terrain and positioning the operator further away from any of the mine blasts. That is, by using a helicopter we would remove people from the area while mines are being detonated. A GPS tracking system may also be used to monitor where the helicopter has been to map clear zones and danger zones where mines still needs to be cleared.

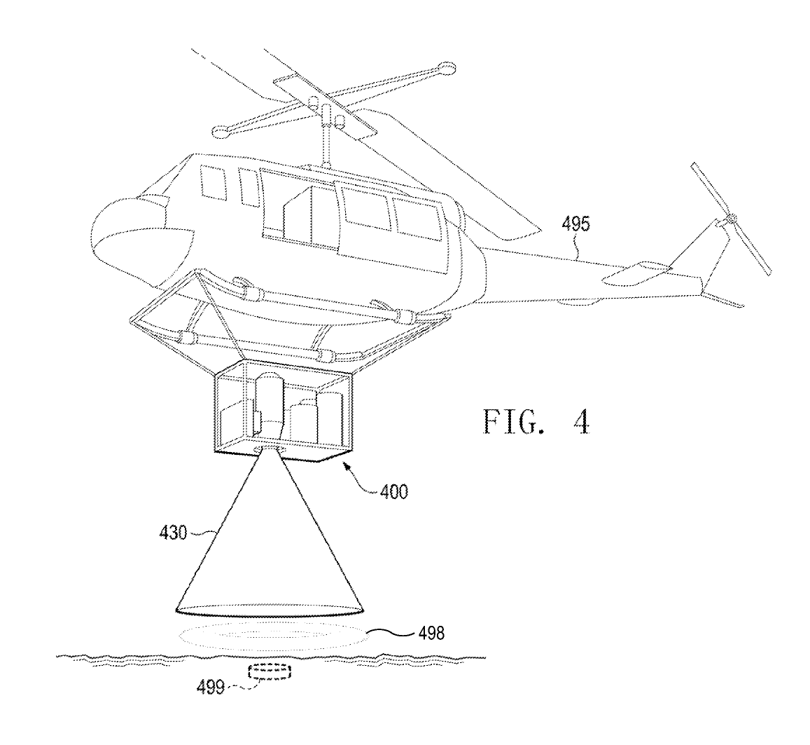

FIG. 4 is a detail diagram of the vortex ring generator 400 shown in FIG. 3 mounted to a helicopter 495 according to embodiments of the invention. Here, the VRG 400 is positioned under the helicopter 495 so that the cone 430 of the VRG system is directed toward the ground. In operation, the VRG 400 generates vortex rings of air 498, which travel from the cone 430 toward the ground to detonate any landmines 499 placed in the ground.

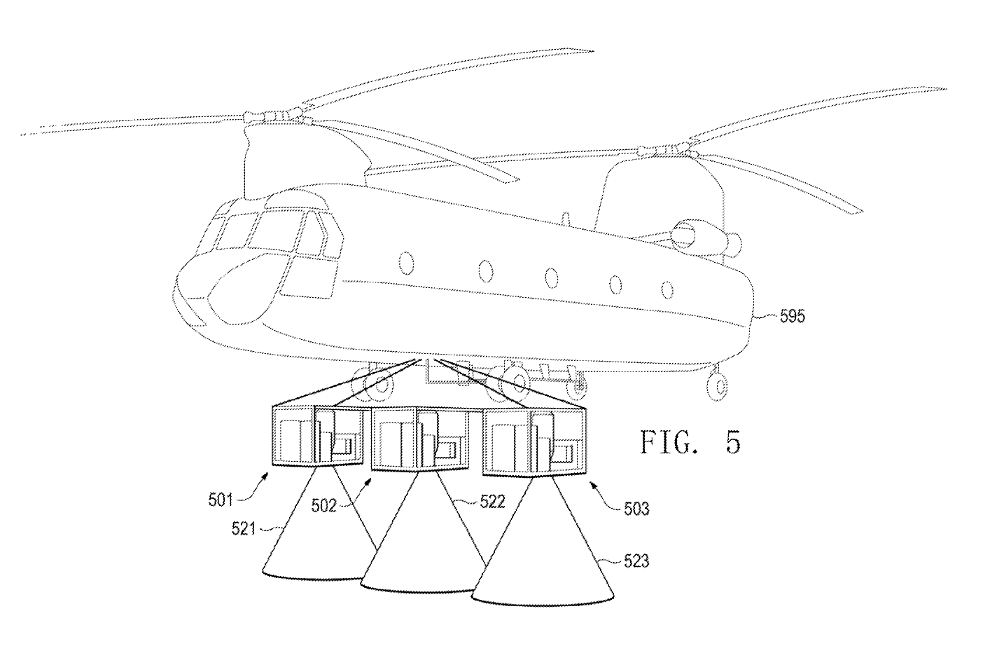

FIG. 5 is a detail diagram of three of the vortex ring generators 501, 502, 503 shown in FIG. 3 mounted in parallel to a helicopter 595 according to embodiments of the invention. Again the respective cones 521, 522, 523 of the VRG systems 501, 502, 503 are directed toward the ground. The parallel placement of vortex ring generator systems 501, 502, 503 allows for a larger footprint of pressure with each pass of the helicopter 595. This allows an area to be cleared of mines in less time and with fewer total passes. Although three VRG systems 501, 502, 503 are shown in parallel in FIG. 5, various other numbers of VRG systems may be mounted in parallel.

FIG. 6 a detail diagram of the vortex ring generator 600 shown in FIG. 3 mounted to a loader 695 according to embodiments of the invention. Here, an extended arm 696 of the loader 695 is used to hold and position the VRG system 600. This positioning includes directing the cone 620 of the VRG system 600 toward the ground so that vortex rings of air 698 can impact the ground and detonate any nearby landmines Although a loader 695 is shown in FIG. 6, other types of land-based vehicles may be used to carry a VRG system 600 over a designated area of land. For example, a Hummer or tank with an extended arm 696 positioned in front of the vehicle to hold a VRG system 600 may be used in other embodiments.

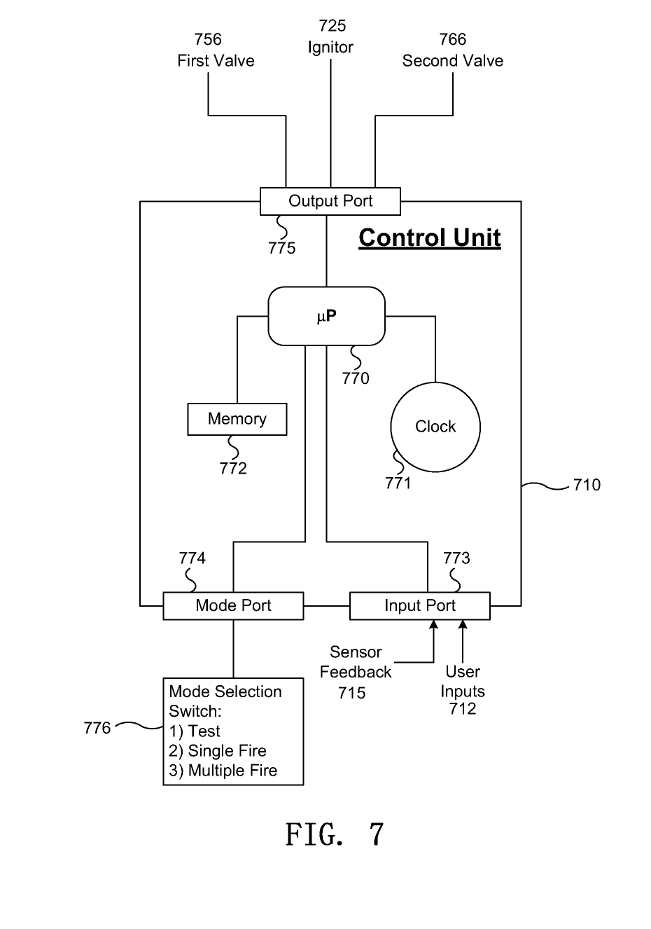

FIG. 7 is a functional block diagram of a control unit 710 for a vortex ring generator according to embodiments of the invention.

The control unit 710 of the VRG system is used to control the firing of the vortex rings. The control unit 710 may control at least one component of the fueling 756, 766 or ignition system 725 to control the firing of the vortex rings. In the embodiments shown above, the control unit 710 is connected to valves 756, 766 on both the propane and oxygen fueling systems, as well as being connected to the ignition system 725 in the combustion chamber. By modulating these fuel valves and controlling the ignition needed for the explosion in the combustion chamber, the control unit 710 controls the firing of the vortex rings. In some embodiments, the control unit 710 may be a laptop or remote computer hooked up to the fueling and ignition systems to control the vortex ring generation. In other embodiments, the control system 710 may include a standalone electronic unit that can operate the VRG system to fire the vortex rings. Although FIG. 7 illustrates a stand-alone control unit 710, the components of this unit could be part of a laptop or other remote control system used to regulate the fueling valves and ignition system.

As shown in FIG. 7, the control unit 710 may include an output port 775 to provide signals to the fueling valves (e.g., solenoid valves) 756, 766 and ignition system 725 to control the firing of the VRG system. Additionally, the control unit 710 may include a microprocessor 770, memory 772, and clock 771 to control the timing of the signals sent through the output port. A mode port 774 may also be to allow a user to select between a variety of firing modes 776, such as a test mode, a single fire mode, or a multiple fire mode.

The control unit 710 may also include one or more input ports 773 that are capable of receiving user inputs 712 or sensor feedback 715. User inputs 712 may include firing rate information, firing intensity information, firmware updates, other information that a user may communicate to the control unit 710. The sensor feedback 715 may include signals from one or more sensors positioned around the VRG system or target. These sensors may include pressure sensors in the combustion chamber, temperature sensors in the combustion chamber, pressure sensors in the cone, or a target sensor, such as a camera, audio sensor, pressure sensor, etc. The processor 770 may receive feedback signals from these sensors and automatically adjust firing parameters of the VRG by controlling the signals sent through the output ports 775. In one example, an array of pressure sensors is used throughout the cone to determine the speed of gases leaving the cone, and hence the rate of fire from the VRG.

The control unit 710 may also record data about the firing rates, firing patterns, sensor feedback, correction steps, etc. that can be later communicated to an operator. Additionally, the control unit 710 may include an integrated GPS unit or receive GPS data from an external unit to record mapping data.

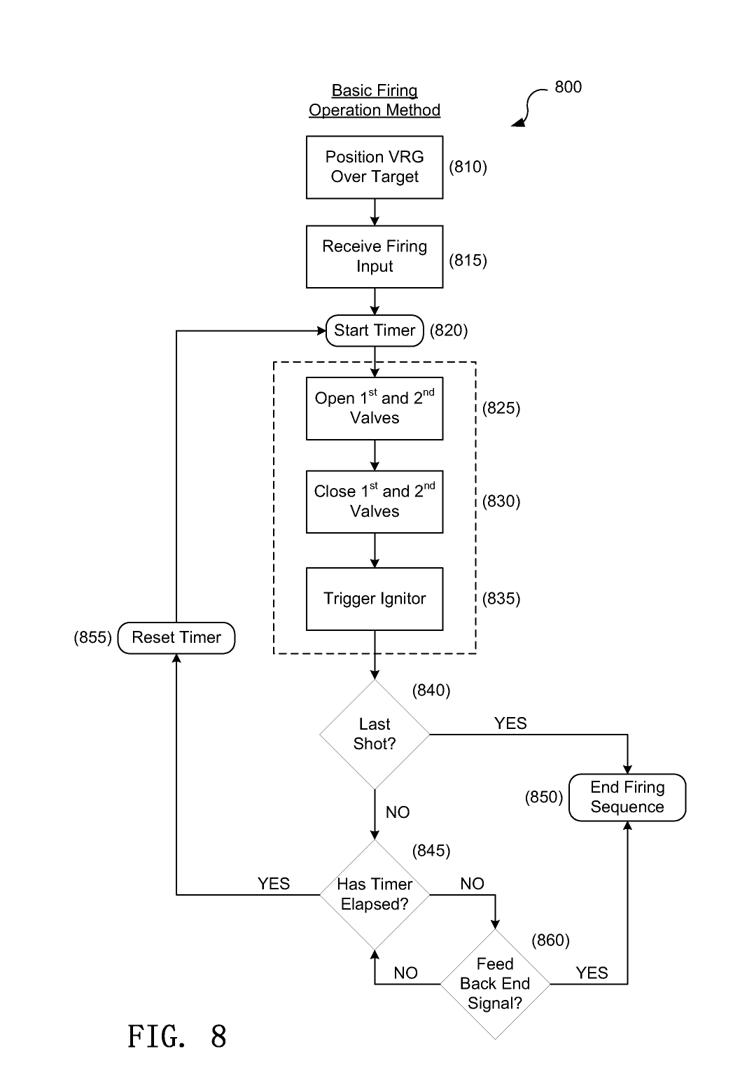

FIG. 8 is a flow diagram of a method of generating a vortex air ring with a vortex ring generator according to embodiments of the invention.

Referring to the method shown in FIG. 8, an example firing session 800 may include positioning the VRG over a target 810, receiving a firing input 815, and starting a timer 820. In a single shot mode, the step of initiating a timer 820 may be skipped since only one shot will be fired for the received firing instructions. The first and second valves are then opened 825 and closed 830 to allow a predetermined amount of fuel to enter the combustion chamber. An ignition system is then triggered 835 to create an explosion in the combustion chamber and generate a vortex ring. The dashed rectangle represents the basic firing process for the VRG in generating a vortex ring. Next, it is determined whether the generated vortex ring was the last shot 840. Again, if the VRG is in a single shot mode, the process may skip this step 840 and proceed to the firing sequence end process 850. However, for a multiple shot burst session, the processor may determine if the last shot has been fired 840. If so, the firing session ends with firing sequence end process 850. However, if the last shot has not been fired, the processor checks to see if the timer has elapsed 845. If it has not, the processor further checks to see if any feedback signals have been received to alter or end the firing rate or firing process 860. If a feedback signal indicates that the firing session should end in process 860, such as when the combustion chamber goes above a certain safe temperature, or a target sensor indicates that the target has been hit, the method proceeds to the firing sequence end process 850.

If the feedback signal simply indicates that an adjustment is to be made in process 860, a required adjustment may be made and the processor returns to checking on the timer 845. When the time on the timer has elapsed in process 845, the timer is reset 855 and then started again 820 followed by repeating the firing process 825, 830, 835 discussed above. The number of shots in the automatic burst mode may allow for set number of shots to be automatically triggered without the need for further operator input. Variations to this method exist in other embodiments, where, for example, the timer is eliminated, and user control stops the multiple firing of the VRG system.

As mentioned above, one useful function of this disclosed system is for the clearing of land mines. However, other embodiments of this VRG system may be used to trigger avalanches near ski resorts or highways, pest removal, fabrication techniques for scratch-prone surfaces, or other uses.

Some embodiments of the invention have been described above, and in addition, some specific details are shown for purposes of illustrating the inventive principles. However, numerous other arrangements may be devised in accordance with the inventive principles of this patent disclosure. Further, well known processes have not been described in detail in order not to obscure the invention. Thus, while the invention is described in conjunction with the specific embodiments illustrated in the drawings, it is not limited to these embodiments or drawings. Rather, the invention is intended to cover alternatives, modifications, and equivalents that come within the scope and spirit of the inventive principles set out herein.

1. A vortex ring generating system comprising:
a first fuel supply container;
a second fuel supply container;
a combustion chamber connected to the first fuel supply container via a first fuel line, and connected to the second fuel supply container via a second fuel line;
a plurality of fuel control valves respectively positioned along the first and second fuel lines to control the flow of fuel;
an ignitor connected to the combustion chamber;
a vortex cone connected to the combustion chamber, the cone structured to form vortex rings of air in response to fuel in the combustion chamber being ignited by the ignitor; and
a control unit connected to the ignitor and at least a portion of the fuel control valves, the control unit configured to operate the ignitor and connected fuel control valves to initiate combustion blasts in the combustion chamber.

2. The system of claim 1, further comprising a housing that encloses the combustion chamber.

3. The system of claim 2, where the housing includes a recoil dampener connected to the combustion chamber.

4. The system of claim 2, where the first and second fuel supply containers are enclosed in the housing.

5. The system of claim 1, where the control unit includes:
a timer circuit;
a memory; and
a processor configured to control operation of the ignitor and connected fuel valves.

6. The system of claim 5, where the memory is configured to store instructions used by the processor to automatically initiate combustion blasts in the combustion chamber at intervals timed by the timer circuit.

7. The system of claim 5, where the memory is configured to record data associated with the generated vortex rings.

8. The system of claim 5, where the control unit includes a user interface configured to receive inputs from a system operator.

9. The system of claim 8, where the user interface is a remote computer connected wirelessly to the processor.

10. The system of claim 1, further comprising feedback sensors positioned in the combustion chamber, the feedback sensors connected to the control unit.

11. The system of claim 1, further comprising feedback sensors positioned in the vortex cone, the feedback sensors connected to the control unit.

12. The system of claim 1, where the vortex cone includes a narrow end and a wide end, the narrow end being directly connected to the combustion chamber.

13. The system of claim 12, where a size ratio between the narrow end of the vortex cone and the wide end of the vortex cone is about 1/12.

14. The system of claim 12, where a size ratio between the narrow end of the vortex cone and a length of the vortex cone is about 1/21.

15. A method of generating a multiple shot sequence of vortex air rings, the method comprising:
receiving an input to initiate the multiple shot sequence;
generating a vortex air ring, where generating the vortex air ring includes:
opening first fuel valve to provide a first fuel to a combustion chamber,
opening second fuel valve to provide a second fuel to the combustion chamber, and
igniting the first and second fuels in the combustion chamber;
determining if a predetermined number of vortex rings have been generated for the multiple shot sequence; and
automatically repeating the steps for generating vortex air rings until the predetermined number of vortex rings have been generated.

16. The method of claim 15, further comprising automatically initiating a second multiple shot sequence of vortex air rings.

17. The method of claim 15, further comprising receiving data from feedback sensors after generating the vortex air ring.

18. The method of claim 17, further comprising ending the multiple shot sequence of vortex air rings when the data received from the sensors indicate a stop condition.

19. The method of claim 17, where the steps for generating vortex air rings are automatically repeated in response to the data received from the feedback sensors.

20. The method of claim 15, further comprising:
initiating a timer prior to generating the vortex air ring; and
delaying the automatic repeating of steps for generating vortex air rings until the timer has elapsed.
